(19) United States
(12) Patent Application Publication
(10) Pub. No.: US 2021/0389131 A1
(43) Pub. Date: Dec. 16, 2021

(54) METHOD FOR DRIVING THE DISPLAY OF INFORMATION ON A SCREEN BANNER EQUIPPING A BOAT WHEELHOUSE

(71) Applicant: IXBLUE, Saint-Germain-en-Laye (FR)

(72) Inventors: Jean-Michel HUBERT, Saint-Germain-en-Laye (FR); Hugues DE BECDELIEVRE, Saint-Germain-en-Laye (FR); Josselin MANCEAU, Saint-Germain-en-Laye (FR)

(21) Appl. No.: 17/287,008

(22) PCT Filed: Oct. 18, 2019
(86) PCT No.: PCT/FR2019/052480

§ 371 Date: Apr. 20, 2021

(30) Foreign Application Priority Data
Oct. 22, 2018 (FR) 1859748

(51) Int. Cl. G01C 21/20; G06T 7/10; G06T 11/00; B63B 49/00; G08G 3/00; B63B 79/10

(52) U.S. Cl. CPC G01C 21/203; G06T 7/10; B63B 79/10; B63B 49/00; G08G 3/00; G06T 11/00

(57) ABSTRACT

Disclosed is a method for driving the display of information on a screen banner equipping a boat wheelhouse control post, the control post including at least one image sensor oriented towards the bow of the boat. The method includes: —a step of acquiring, by means of each image sensor, an image representing the environment ahead of the boat, —a step of processing the image so as to detect each noteworthy zone of this image, and —a step of driving the screen banner so that its displays the image and, superimposed with this image, at least one graphic element distinguishing the noteworthy zone.

### CROSS-REFERENCE TO RELATED APPLICATIONS

This application is the U.S. national phase of International Application No. PCT/FR2019/052480 filed Oct. 18, 2019 which designated the U.S. and claims priority to FR 1859748 filed Oct. 22, 2018, the entire contents of each of which are hereby incorporated by reference.

### BACKGROUND OF THE INVENTION

### Field of the Invention

The present invention generally relates to boat maneuvering aids.

It more particularly relates to a method for controlling the display of information on one or several screens installed in a control centre of a boat bridge.

It also relates to a control centre of a boat bridge, comprising a window wall open to the front of the boat and at least one control console placed behind the window wall.

It also relates to a boat fitted with such a control centre.

### Description of the Related Art

Nowadays, great size ships are fitted with computer systems enabling them to accurately determine their location on the globe, the locations of other ships cruising in their area, the coast locations . . . .

The information acquired by these computer systems is generally intended to be processed then displayed on screens installed on the ship bridge.

This information is hence offset with respect to the view the officer of the watch has of the environment (through the window wall of the ship).

Hence, the officer of the watch may have difficulty to grasp this information, as it could sometimes be difficult for him to make the link between the information displayed on the screen and the view he has of the environment through the window wall.

To solve this problem, the solution consists in fitting the boats with heads-up display systems, such as those which are found today in cars. These systems are then arranged fixedly, opposite the officer of the watch's seat.

The drawback of such a system is that it is usable only if the officer of the watch is sitting in his seat, in the axis of the heads-up display system. Now, in practice, the officer of the watch has often to move on the bridge, so that he has no longer access to this information.

### SUMMARY OF THE INVENTION

In order to remedy the above-mentioned drawback of the state of the art, the present invention proposes to use a strip of screen(s) positioned along the window wall, above or below the latter.

More particularly, it is proposed according to the invention a method for controlling the display of information on a strip of screen(s) installed in a control centre of a boat bridge, the control centre comprising at least one image sensor directed towards the front of the boat. According to the invention, the method comprises:

a step of acquiring, by means of each image sensor, an image representing the environment ahead of the boat,

a step of processing said image in order to detect each focus area of this image, and

a step of controlling the strip of screen(s) so that the latter displays the image and, overlaid on this image, at least one graphic element marking out said focus area.

The invention also proposes a boat navigation aid device comprising:

a screen strip adapted to be integrated to a control centre of the boat, and

a computer that is adapted to be connected to at least one image sensor directed towards the front of the boat, and that is adapted to control the screen strip according to the above-mentioned control method.

The invention also proposes a control centre of a boat bridge, comprising a window wall open to the front of the boat, at least one control console placed behind the window wall, a strip of screen(s) positioned between the window wall and the control console, at least one image sensor directed towards the front of the boat, and a computer adapted to control the strip of screen(s) according to a control method as mentioned hereinabove.

Hence, thanks to the invention, the strip of screen(s) can display a view of the environment that it substantially identical to that which is viewed by the officer of the watch through the window wall, with useful information added thereon.

Hence, this screen strip does not modify the officer of the watch's habits, who can moreover move on the bridge while benefiting from the information displayed on the strip of screen(s).

This screen strip is preferably positioned above or below the window wall, in such a way as the view through the window wall is superimposed to the view displayed on the screen strip, which facilitate the understanding of the displayed information by the officer of the watch.

Other advantageous and non-limitative features of the control method according to the invention are the following:

the control centre comprising a control console and window wall open to the front of the boat, at the control step, the image displayed on the screen strip shows a view of the environment that is similar to that which is visible through the windrow wall from the control console;

said graphic element is a symbol adapted to highlight the focus area on said image;

said graphic element is a thumbnail displaying information characterizing the focus area;

the boat comprising at least one other sensor adapted to acquire external data other than images, said external data relating to the boat environment, at the acquisition step, it is provided to acquire at least one external data using said other sensor, at the processing step, it is provided to check the matching between said focus area and said external data, and, if the matching is checked, at the displaying step, the thumbnail displays information obtained from said external data;

said other sensor is an automatic boat identification system (AIS) or a remote-sensing system (RADAR, SONAR, LIDAR . . . ).

Other advantageous and non-limitative features of the device and the control centre according to the invention are the following:

the screen strip is positioned above the window wall;

the screen strip comprises several screens arranged in an arc of a circle around the control console;

the screen strip comprises between 1 and 7 screens;

the window wall is consisted of glasses that are all inert.

The invention also relates to a boat comprising a control centre as mentioned hereinabove.

### BRIEF DESCRIPTION OF THE DRAWINGS

The following description in relation with the appended drawings, given by way of non-limitative examples, will allow a good understanding of what the invention consists of and of how it can be implemented.

In the appended drawings:

FIG. 1 is a schematic perspective view of a control centre according to the invention;

FIGS. 2 and 3 are schematic rear and side views of the control centre of FIG. 1;

FIGS. 4 and 5 are illustrations of the views that can be displayed by the strip of screens of the control centre of FIG. 1; and

FIG. 6 is a schematic side view of a ship fitted with the control centre of FIG. 1.

### DESCRIPTION OF THE PREFERRED EMBODIMENTS

In FIG. 6 is represented a boat, and more precisely a ship 1, intended to navigate in open seas.

This ship 1 conventionally comprises a hull 3 topped with a bridge 2 that accommodates the control centre 10 of this ship 1.

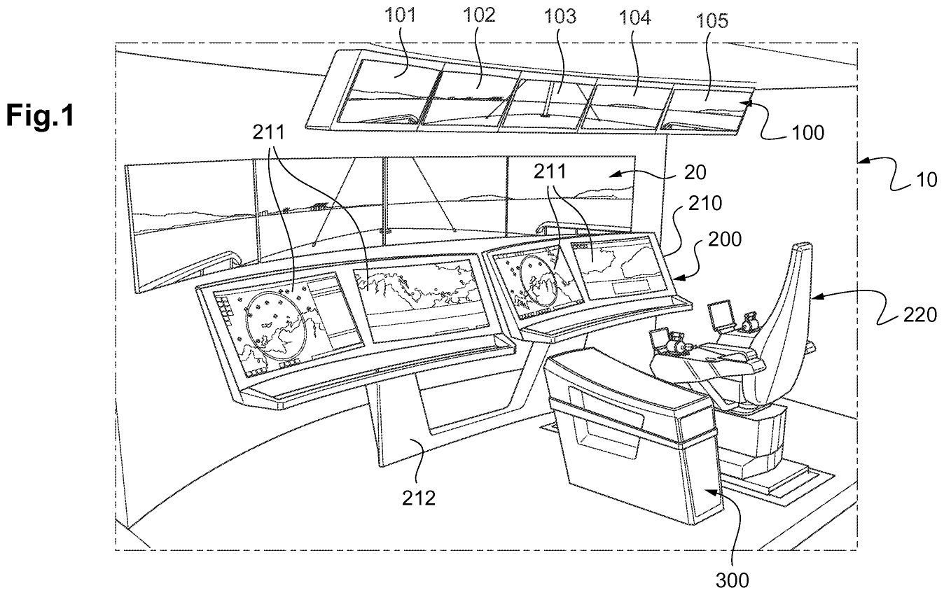

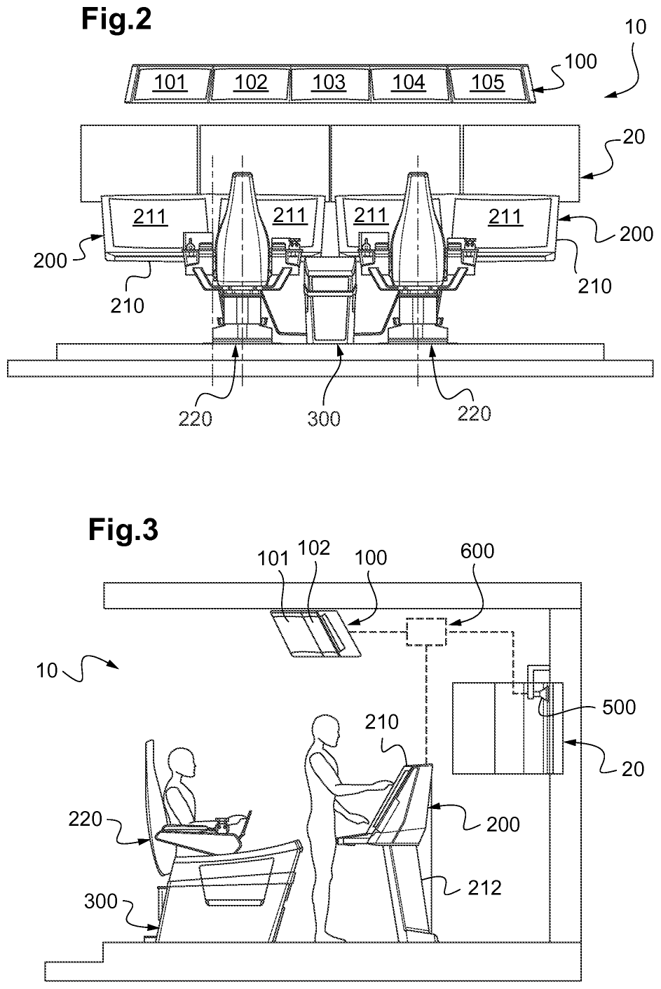

FIGS. 1 to 3 show an exemplary embodiment of this control centre 10.

As shown in these figures, the control centre 10 is installed behind the window wall 20 formed by a row of windows arranged in a front wall of the bridge 2 and opening to the bow of the ship 1.

These windows are herein closed by transparent glasses that are inert (i.e. devoid of electronics, liquid crystals . . . ). They allow the officer of the watch of the ship 1 to observe the environment ahead of the ship 1.

The control centre 10 comprises at least one control console 200 enabling the officer of the watch to manoeuvre the ship 1 and to obtain the information required for maneuvering this ship 1.

In the embodiment shown here, the control centre 10 herein includes two identical control consoles 200, placed side-by-side.

These control consoles 200 can be shortly described.

Each control console 200 comprises information display means 210 and a seat 220 (only one seat is shown in FIGS. 1 and 3 for clarity of the figures).

The information display means 210 herein comprise two screens 211 fitted side-by-side into a same frame, said frame being itself attached to the ground of the bridge 2 by means of a base 212. As an alternative, it could be provided that each base has a pivoting mobility about a vertical axis.

Each seat 220 comprises a seat base, a back articulated to the seat base and two armrests fitted with means for piloting the ship 1.

The piloting means can for example be in the form of buttons, control joysticks, touch screens . . . .

These seats 220 are mounted on the ground of the bridge 2 with a fore-and-aft sliding mobility.

The seats 220 and screens 211 are positioned in such a manner that the officer of the watch, once installed in one of the seats 220, has a view over the whole window wall 20. For that purpose, the screens 211 are positioned at the bottom of his field of view, whereas the window wall is at mid-height of his field of view (when he looks horizontally forwards).

It will be further noted that the control centre 10 comprises a central console 300 positioned between the two seats 220.

This central console 300 is provided with auxiliary piloting devices and/or auxiliary display devices. Herein, this central console 300 notably comprises, in its upper part located near the armrests of the seats 220, a touch screen on which can be displayed navigation information, and a free area on which other applications can be added or displayed in complement of that which is displayed on the screens 211.

As can be seen in FIGS. 1 to 3, the control centre 10 according to the invention is further fitted with a strip of screen(s) 100, which is herein positioned at the top of the officer of the watch's field of view.

This screen strip 100 comprises several screens 101-105 housed in distinct or common racks.

Preferably, between one and seven screens are provided. Here, the ship 1 being of mean size, exactly five screen 101-105 are provided.

This screen strip 100 is herein positioned higher than the upper edge of the window wall 20, so that it does not hide the latter, even when the officer of the watch is standing on the bridge 2.

This screen strip 100 is placed inside the bridge 2, between the window wall 20 and the control consoles 200, so that the officer of the watch can see these screens 101-105 when he is sitting in his seat 220.

The screen strip 100 is centred with respect to the window wall 20. In other words, the centre of the screen strip 100 and the centre of the window wall 20 are located in a same vertical plane parallel to the longitudinal axis of the ship 1. The screens 101-105 are arranged in an arc of a circle around the two control consoles 200.

They are attached to the ceiling of the bridge 2 and tilted towards the control consoles 200 so as to facilitate their viewing by the officer of the watch.

More precisely, here, the screens 101-105 are arranged in a conical pattern for optimizing the officer of the watch's viewing angle when the latter is sitting in either one of the two seats 220.

The screens 101-105 are hence positioned on a cone of vertical axis, whose apex angle is comprised between 40 and 90 degrees and is for example equal to 60 degrees.

The control centre 10 moreover comprises at least one image sensor that is directed towards the front of the ship 1 in order to be able to acquire raw images on which appears the environment ahead of the ship 1.

It could be provided that the control centre 10 comprises a single camera, of the “panoramic” type, having a wide field of view (higher than 100 degrees). Here, the control centre 10 will rather comprise several cameras directed horizontally, pointing in different directions.

In the considered example, the control centre 10 comprises exactly three cameras, a camera directed towards the front of the ship 1 and two camera directed towards the right and the left, respectively, of the ship 1. These two cameras have optical axes that are then inclined with respect to the optical axis of the first camera, with an angle comprised between 15 and 100 degrees, herein equal to 45 degrees.

The interest of using three cameras rather than only one is that it is possible to obtain more accurate images of remote areas of the environment.

As shown in FIG. 3, the cameras 500 are fixed inside the bridge 2, behind the window wall 20. They can hence be attached to the bridge ceiling. As an alternative, they can be attached to the screen strip 100 so as to form with the latter a single-piece unit. That way, the cameras 500 are protected from sea sprays and the raw images are acquired with a view angle very close to the angle with which the officer of the watch observes the environment through the window wall 20.

As an alternative, as shown in FIG. 6, the cameras 501 could be attached above the bridge 2, for example on a vertical mast. In this alternative, the cameras 501 will have a angle of view of the environment that is different from that of the officer of the watch, but they will be able to acquire images of parts of the environment that are not visible from the bridge 2.

The cameras 500 are in any case used to capture raw images of the environment just ahead the ship 10.

The screen strip 100 is mainly intended to display:

an image of the environment that is similar to the view of the environment from the inside of the bridge 2 through the window wall 20, and

information overlaid on this image, so as to generate a display of the “augmented reality” type.

To control the display of these images and information on the screen strip 100, the control centre 10 comprises a computer 600.

This computer 600 contains at least one processor (CPU), at least one memory and different input and output interfaces.

Thanks to its memory, the computer memorizes data used within the framework of the estimated position correction method that will be described hereinafter.

It hence memorizes a database whose architecture will be detailed hereinafter, and a computer application consisted of computer programs comprising instructions whose execution by the processor allows the computer to implement the method for controlling the screens 101-105.

The computer 600 is adapted to control the five screens 101-105 of the screen strip 100, thanks to its output interfaces.

The computer 600 is adapted to receive the raw images acquired by the three cameras 500, thanks to its input interfaces.

It is also adapted to collect external data obtained by means of other devices of the ship 10.

Among these other devices, the ship 1 comprises for example an automatic ship identification system, better known as AIS.

It also comprises for example a remote-sensing system, and more precisely here a RADAR system.

It finally comprises a satellite positioning system (here a GPS system associated with an ECDIS mapping system).

According to the invention, the computer 600 is adapted to implement an algorithm for controlling the screens 101-105 that includes three main steps:

a step of acquiring an image representing the environment ahead of the ship 1,

a step of processing this image in order to detect therein potential focus area(s), and

a step of controlling the screens 101-105 of the screen strip 100 so that they display the above-mentioned image and, overlaid on this image, a graphic element marking-out each detected focus area.

These three steps will now be described in detail.

During the first, acquisition step, the computer 600 acquires the last raw image captured by each of the cameras 500.

Then, it merges the three acquired raw images so as to form a single and same image to be displayed, hereinafter called “image Img1”.

The obtained image Img 1 has a panoramic shape, and proportions (height/width) that correspond to the proportions of the unit formed by the five screens 101-105 of the screen strip 100.

This merging operation can consist in simply placing the raw images side-by-side (with a potential overlapping of the raw images if areas of the environment appear on several raw images), then cutting this unit at the desired size.

During this first step, the computer also acquires the external data obtained from the AIS, RADAR and ECDIS systems.

During the second, processing step, the computer 600 applies to the image Img1 a processing algorithm for detecting focus areas of this image.

A focus area corresponds to an area of the environment that is useful to know for maneuvering the ship 1 in complete safety.

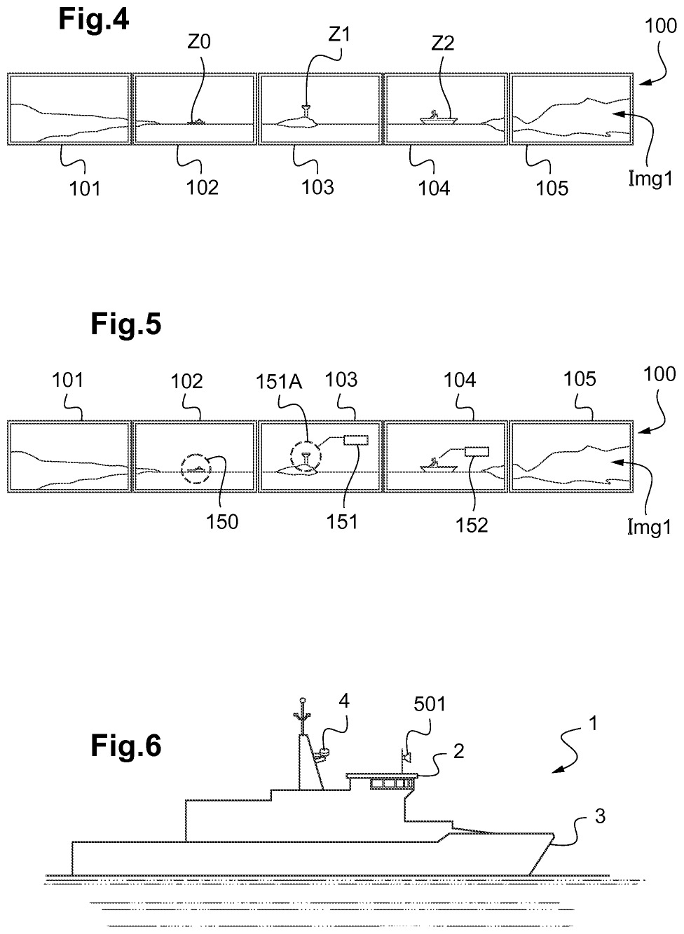

As shown in FIG. 4, three types of focus areas are distinguished:

fixed obstacles Z0, which correspond for example to reefs or isolated dangers,

sea-marks Z1, which correspond to points of the environment listed in the mapping system, and from which it is possible to locate the ship,

boats Z2.

The way the image processing algorithm is elaborated won't be described in detail herein. It will only be said that machine learning techniques are preferred, considering the quality of the results they provide.

At the end of this operation, the computer 600 stores the results of processing of the image Img1 in the database provided for that purpose.

This database will for example include a record for each detected focus area Z0, Z1, Z2.

Each record includes several fields, among which:

the coordinates, in pixel, of the focus area on the image Img1,

the coordinates, in longitude and latitude, of the focus area on the globe,

the classification of this focus area (sea-mark, fixed obstacle, boat).

The coordinates, in longitude and latitude, of the focus area on the globe will be deduced from the coordinates, in pixel, of the focus area on the image Img1, as well as from the heading of the ship 10 and the GPS position of the ship 10.

Once the results of processing of the image Img1 recorded in the database, the computer 600 checks if a match exists between these results and the data obtained from the AIS, RADAR and ECDIS (mapping) systems. It may also be provided to check if a match exists between these results and the data obtained from other sensors potentially installed on board.

In practice, the computer 600 determines if each detected focus area Z0, Z1, Z2 is also mapped by the ECDIS system and/or referenced by the AIS system and/or detected by the RADAR system.

More precisely, the computer 600 checks if the coordinates, in longitude and latitude, of each focus area classified as a “fixed obstacle” effectively match with a danger listed by the ECDIS system and/or with a danger viewed by the RADAR system. As an alternative, it could also use other mapping systems to check that the coordinates of each focus area classified as a “fixed obstacle” effectively match with a listed danger.

The computer 600 also checks that the coordinates, in longitude and latitude, of each focus area classified as a “sea-mark” effectively match with a sea-mark listed by the ECDIS system. Here again, as an alternative, it could use other mapping systems.

The computer 600 finally checks that the coordinates, in longitude and latitude, of each focus area classified as a “boat” effectively match with a boat listed by the AIS system.

If this is not the case, the record associated with the corresponding focus area is distinctly stored into the database and remains accessible by the computer if need be.

In the opposite case, the information obtained from the ECDIS or AIS system is stored into the corresponding record of the database.

During the third, control step, the computer 600 controls the display of the image Img1 by the screens 101-105 of the screen strip 100 (see FIG. 4).

At this stage, the officer of the watch can hence observe substantially the same view through the window wall 20 and on the screen strip 100.

An information filtering application is made available to the officer of the watch. This application, herein developed in WEB technology, can be displayed on an Internet browser installed on a workstation connected to the network (this workstation being incorporated to the control centre or to a mobile tablet or to the seat 220). This application is operable to filter the types of objects to be highlighted in augmented reality on the screen strip 100. It is also operable to ensure that the objects located at a higher distance than a determined threshold are not displayed or highlighted.

More precisely, herein, thanks to this application, the computer 600 can control the display, in overlay on the image Img1, of graphic elements making it possible to mark out the focus areas Z0, Z1, Z2 from the rest of the image Img1 (see FIG. 5).

By way of illustrative example, the computer 600 can hence control the display of a symbol 150, such as a circle around each focus area Z0 corresponding to a fixed obstacle.

It can also control the display of a symbol 151A such as a circle about each focus area Z1 corresponding to a sea-mark, and a thumbnail 151 linked to this symbol 151A. Then, the thumbnail can display information obtained from the ECDIS system (or other mapping systems) and characterizing this sea-mark (GPS position of the sea-mark, heading towards the sea-mark, name of the sea-mark . . . ).

It can also control the display of a thumbnail 152 near each focus area Z2 corresponding to a boat, this thumbnail 152 displaying information obtained from the AIS system and characterizing this boat (name of the boat, GPS position, cap, speed . . . ).

Generally, the computer could be programmed so that the screen strip can display any geo-referenced information transmitted by the control system (areas, routes or special points of the ECDIS system, tracks transmitted by the RADAR system or by any other sensor), whether there is or not correlation between the results of the image processing step and the data obtained from the control system.

The present invention is not limited in any way to the embodiment described and represented, but the person skilled in the art will be able to apply any alternative in accordance with the invention.

Hence, it could be provided that the screen strip includes a single one screen, in the wide-screen format.

According to another alternative, it could be provided that the officer of the watch can use the screen strip 100 to display, over all or part of this screen strip, other applications than the above-mentioned ones, linked to the seafarer profession (typically, ARPA, CONNING applications . . . ) or interfaces representing the data transmitted by the navigation sensors (repeaters).

In the embodiment described with reference to the figures, the image Img1 displayed on the screen strip 100 is a view that is closer to that the officer of the watch has from his seat 220 when he looks through the window wall 20.

It is then understood that, when the officer of the watch moves on the bridge, the view he has of the environment is similar but not identical to the image Img1.

In another embodiment of the invention, it could then be provided to detect the position of the officer of the watch in the boat, then to display on the screen strip 100 a view of the environment that is the closest possible to that the officer of the watch has, in consideration of his position on the bridge. This view could moreover be displayed on a portable screen (tablet, binoculars . . . ).

1. A method for controlling the display of information on a screen strip installed in a control centre of a bridge of a boat, the control centre comprising at least one image sensor directed towards the front of the boat,
the method comprising:
a step of acquiring, by means of each image sensor, an image representing the environment ahead of the boat,
a step of processing said image in order to detect each focus area of this image, and
a step of controlling the screen strip so that the screen strip displays the image and, overlaid on this image, at least one graphic element marking out said focus area.

2. The control method according to claim 1, wherein, the control centre comprising a control console and a window wall open to the front of the boat, at the control step, the image displayed on the screen strip shows a view of the environment that is similar to that which is visible through the window wall from the control console.

3. The control method according to claim 1, wherein said graphic element is a symbol adapted to highlight the focus area on said image.

4. The control method according to claim 1, wherein said graphic element is a thumbnail displaying information characterizing the focus area.

5. The control method according to claim 4, wherein, the boat comprising at least one other sensor adapted to acquire external data other than images, said external data relating to the environment of the boat, at the acquisition step, it is provided to acquire at least one external data using said other sensor, at the processing step, it is provided to check the matching between said focus area and said external data, and, if the matching is checked, at the displaying step, the thumbnail displays information obtained from said external data.

6. The control method according to claim 5, wherein said other sensor is an automatic boat identification system or a remote-sensing system.

7. A navigation aid device for a boat, comprising:
a screen strip adapted to be integrated to a control centre of the boat, and
a computer that is adapted to be connected to at least one image sensor directed towards the front of the boat, and that is adapted to control the screen strip according to a control method in accordance with claim 1.

8. The device according to claim 7, wherein the screen strip comprises several screens arranged in an arc of a circle around the control console.

9. The device according to claim 7, wherein the screen strip comprises between 1 and 7 screens.

10. A control centre of a bridge of a boat, comprising:
a window wall open to the front of the boat, and
at least one control console placed behind the window wall,
at least one image sensor directed to the front of the boat, and
a device in accordance with claim 7.

11. The control centre according to claim 10, wherein the screen strip is positioned above the window wall.

12. The control centre according to claim 10, wherein the window wall is consisted of glasses that are all inert.

13. A boat comprising a control centre in accordance with claim 10.

14. The control method according to claim 2, wherein said graphic element is a symbol adapted to highlight the focus area on said image.

15. The control method according to claim 2, wherein said graphic element is a thumbnail displaying information characterizing the focus area.

16. The control method according to claim 3, wherein said graphic element is a thumbnail displaying information characterizing the focus area.

17. A navigation aid device for a boat, comprising:
a screen strip adapted to be integrated to a control centre of the boat, and
a computer that is adapted to be connected to at least one image sensor directed towards the front of the boat, and that is adapted to control the screen strip according to a control method in accordance with claim 2.

18. A navigation aid device for a boat, comprising:
a screen strip adapted to be integrated to a control centre of the boat, and
a computer that is adapted to be connected to at least one image sensor directed towards the front of the boat, and that is adapted to control the screen strip according to a control method in accordance with claim 3.

19. A navigation aid device for a boat, comprising:
a screen strip adapted to be integrated to a control centre of the boat, and
a computer that is adapted to be connected to at least one image sensor directed towards the front of the boat, and that is adapted to control the screen strip according to a control method in accordance with claim 4.

20. A navigation aid device for a boat, comprising:
a screen strip adapted to be integrated to a control centre of the boat, and
a computer that is adapted to be connected to at least one image sensor directed towards the front of the boat, and that is adapted to control the screen strip according to a control method in accordance with claim 5.
